(19) United States
(12) Patent Application Publication
(10) Pub. No.: US 2016/0162099 A1
(43) Pub. Date: Jun. 9, 2016

(54) INPUT DEVICE

(71) Applicant: Primax Electronics Ltd., Taipei (TW)

(72) Inventors: YING-CHE TSENG, Taipei (TW); TUNG-HENG WU, Taipei (TW)

(21) Appl. No.: 14/665,259

(22) Filed: Mar. 23, 2015

(30) Foreign Application Priority Data
Dec. 5, 2014 (TW) 103142357

(51) Int. Cl. G06F 3/041; G06F 13/38; G06F 13/40

(52) U.S. Cl. CPC G06F 3/0416; G06F 13/4022; G06F 13/385

(57) ABSTRACT

An input device includes an input part and a display part. By operating the input part, an input signal is transmitted to an electronic device. The display part is movable relative to the input part. Moreover, a display content of the electronic device may be displayed on the display part. When the display part is accommodated within a receiving slot of the input part, the input part is in a first operating mode. When the display part is pulled out from the receiving slot of the input part, the input part is in a second operating mode. Consequently, the input device of the present invention has operating convenience and slim outer appearance.

### FIELD OF THE INVENTION

The present invention relates to an input device, and more particularly to an input device with a keyboard function.

### BACKGROUND OF THE INVENTION

Generally, the widely-used peripheral input device of a computer includes for example a mouse, a keyboard, a trackball device, or the like. Via the keyboard, the user may input characters and symbols into the computer directly. As a consequence, most users and most manufacturers of the input devices pay much attention to keyboards.

Hereinafter, the structure of a conventional keyboard will be illustrated with reference to FIG. 1. FIG. 1 is a schematic top view illustrating the outer appearance of a conventional keyboard. As shown in FIG. 1, plural keys 10 are installed on a surface of the conventional keyboard 1. These keys 10 are classified into several types, e.g. ordinary keys 101, numeric keys 102 and function keys 103. When one of these keys 10 is depressed by the user's finger, a corresponding signal is issued to the computer, and thus the computer executes a function corresponding to the depressed key. For example, when an ordinary key 101 is depressed, a corresponding English letter or symbol is inputted into the computer. When a numeric key 102 is depressed, a corresponding number is inputted into the computer. In addition, the function keys 103 (F1˜F12) can be programmed to provide various functions. For example, the conventional keyboard 1 is a keyboard of a desktop computer.

Generally, for operating the conventional keyboard 1, the user has to be in front of the keyboard 1 and the computer simultaneously. As such, the user can view a display screen of the computer while operating the conventional keyboard 1. Since the user has to be in front of the computer, the operating behavior of the user is restricted by the conventional keyboard 1.

Therefore, it is important to enhance the operating utilization of the keyboard.

### SUMMARY OF THE INVENTION

An object of the present invention provides an input device with enhanced operating utilization.

In accordance with an aspect of the present invention, there is provided an input device. The input device is in communication with an electronic device. The input device includes an input part and a display part. The input part is in communication with the electronic device. In response to an input operation on the input part, an input signal is transmitted from the input part to the electronic device. The input part includes a receiving slot. The display part is selectively accommodated within the receiving slot or exposed outside the receiving slot. When the display part is moved relative to the input part to be exposed outside the receiving slot, a display content on a display screen of the electronic device is displayed on the display part. When the display part is accommodated within the receiving slot, the input part is in a first operating mode. When the display part is moved relative to the input part to be exposed outside the receiving slot, the input part is in a second operating mode.

From the above descriptions, the input device of the present invention comprises the input part and the display part. In the input part, a touch control module may be triggered through touch control. Moreover, the input part further comprises a first display module. According to the user's requirement, different panel layouts may be selectively displayed on the first display module in order to provide different inputting functions. The display part may be moved relative to the input part so as to be accommodated within the input part or exposed outside the input part. Moreover, the display content on the display screen of the electronic device which is in wireless communication with the input device may be displayed on the display part. Since the input part is implemented with a touch panel, the input device has slim outer appearance and is easily carried. Moreover, the user may operate the input device to control the electronic device without the need of staying in front of the electronic device. Consequently, the input device of the present invention has operating convenience and slim outer appearance. More especially, since the user can control the electronic device at any site through the input device of the present invention, the operating utilization of the input device is enhanced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outer appearance of a conventional keyboard;

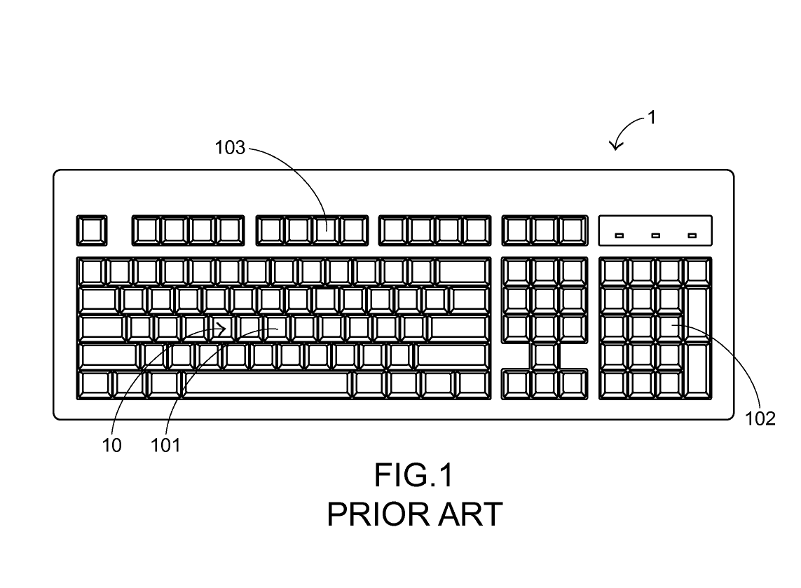

FIG. 2 is a schematic perspective view illustrating the input device according to a first embodiment of the present invention;

FIG. 3 is a schematic functional block diagram illustrating the relationship between an electronic device and the input device according to the first embodiment of the present invention;

FIG. 4 is a schematic perspective view illustrating the input device according to the first embodiment of the present invention, wherein the input part is in a second operating mode;

FIG. 5 is a schematic perspective view illustrating the input device according to a second embodiment of the present invention;

FIG. 6 is a schematic functional block diagram illustrating the relationship between plural electronic devices and the input device according to the second embodiment of the present invention; and

FIG. 7 is a schematic perspective view illustrating the input device according to the second embodiment of the present invention, wherein the input part is in a second operating mode.

### DETAILED DESCRIPTION OF THE PREFERRED EMBODIMENT

For obviating the drawbacks of the prior art technologies, the present invention provides an improved input device.

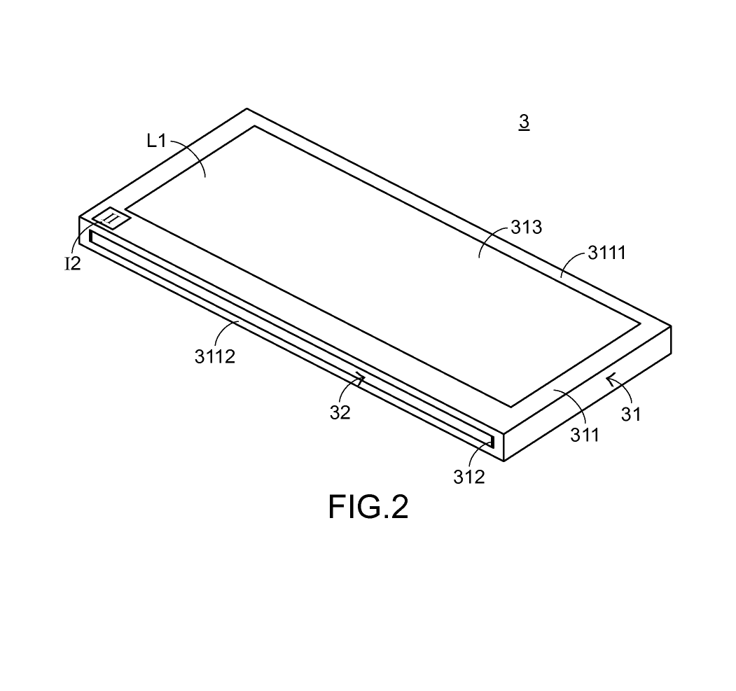

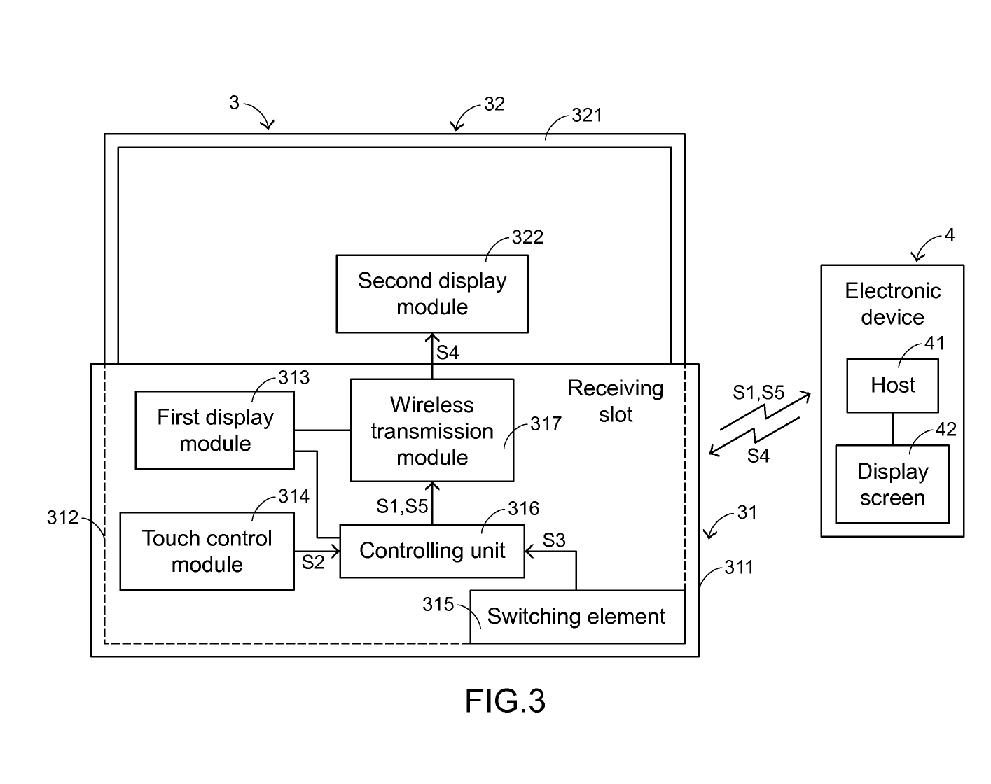

Hereinafter, the structure of an input device according to a first embodiment of the present invention will be illustrated with reference to FIGS. 2 and 3. FIG. 2 is a schematic perspective view illustrating the input device according to a first embodiment of the present invention. FIG. 3 is a schematic functional block diagram illustrating the relationship between an electronic device and the input device according to the first embodiment of the present invention. The input device 3 can be in communication with the electronic device 4 in order to control the electronic device 4. In this embodiment, the input device 3 comprises an input part 31 and a display part 32. The input part 31 is in communication with the electronic device 4. In response to the user's input operation on the input part 31, the input part 31 issues an input signal S1 to the electronic device 4. In this embodiment, the input part 31 comprises a casing 311, a receiving slot 312, a first display module 313, a touch control module 314, a switching element 315, a controlling unit 316 and a wireless transmission module 317. The receiving slot 312 is formed in a lateral surface 3112 of the casing 311 for accommodating the display part 32. In particular, the display part 32 may be accommodated within the receiving slot 312, and moved relative to the input part 31 to be exposed outside the receiving slot 312. When the input device 3 is in communication with a host 41 of the electronic device 4, the display content displayed on a display screen 42 of the electronic device 4 may be displayed on the display part 32. In this embodiment, the electronic device 4 is a desktop computer.

The components of the input part 31 will be illustrated as follows. The first display module 313 is disposed within the casing 311 and exposed to a top surface 3111 of the casing 311. According to the operating mode of the input part 31, different contents are displayed on the first display module 313. The touch control module 314 is stacked on the first display module 313. In response to the user's input operation on the touch control module 314, the touch control module 314 issues a corresponding operating signal S2. The switching element 315 is disposed within the receiving slot 312. When the display part 32 is moved relative to the input part 31 to trigger the switching element 315, the switching element 315 may generate a switching signal S3. The controlling unit 316 is disposed within the input part 31 and connected with the touch control module 314 and the switching element 315. According to the switching signal S3, the controlling unit 316 may switch the operating mode of the input part 31. Moreover, the controlling unit 316 may receive the operating signal S2 from the touch control module 314. After the operating signal S2 is analyzed and processed by the controlling unit 316, the controlling unit 316 outputs the corresponding input signal S1. The wireless transmission module 317 is disposed within the input part 31 and connected with the controlling unit 316. Through the wireless transmission module 317, the input device 3 may be in wireless communication with the host 41 of the electronic device 4. Consequently, the input signal S1 may be transmitted from the wireless transmission module 317 to the host 41, or a display signal S4 corresponding to the display content from the electronic device 4 may be received by the wireless transmission module 317.

In this embodiment, the first display module 313 and the touch control module 314 are collaboratively formed as a touch panel, the wireless transmission module 317 is in communication with the host 41 by a wireless transmission technology, the wireless transmission technology is a Bluetooth transmission technology, and the controlling unit 316 is a microprocessor.

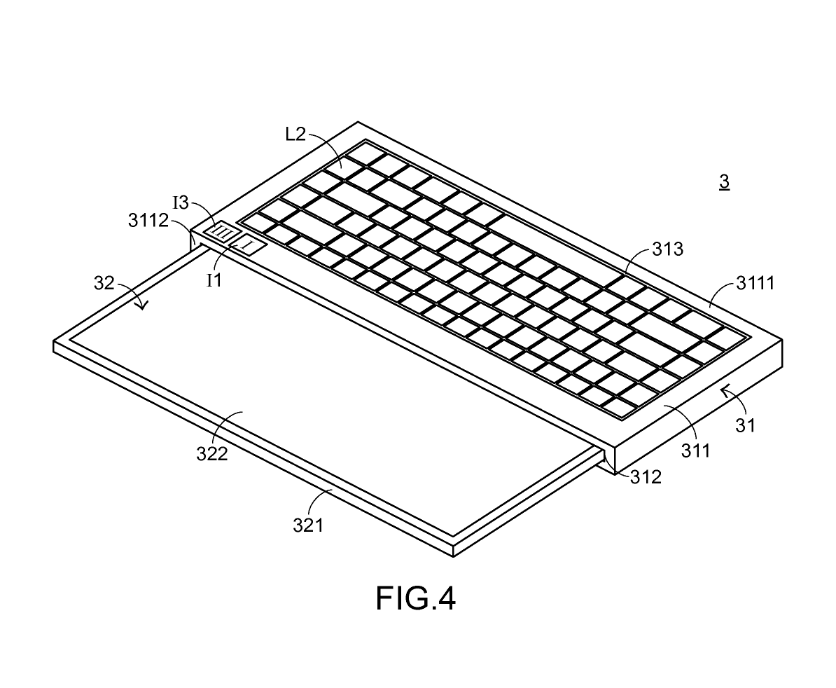

Please refer to FIGS. 2˜4. FIG. 4 is a schematic perspective view illustrating the input device according to the first embodiment of the present invention, wherein the input part is in a second operating mode. In FIG. 4, the outer appearance of the input part 31 of the input device 3 in the second operating mode is shown. Meanwhile, the display part 32 is moved relative to the input part and exposed outside the receiving slot 312. In this embodiment, the display part 32 comprises a frame 321 and a second display module 322. The frame 321 may be moved relative to the input part 31 so as to be accommodated within the receiving slot 312 or exposed outside the receiving slot 312. The second display module 322 is disposed within the frame 321 and exposed to a top surface of the display part 32. The second display module 322 is connected with the wireless transmission module 317. According to the display signal S4 from the electronic device 4, the display content on the display screen 42 may be displayed on the second display module 322. In this embodiment, the second display module 322 is composed of plural organic light-emitting diodes (not shown).

Since the second display module 322 is composed of the plural organic light-emitting diodes, the second display module 322 is flexible. It is noted that the input device of the present invention may be modified. For example, the frame made of a soft material or a flexible material and the flexible second display module 322 may be combined as a randomly bendable display part. Under this circumstance, the receiving slot 312 for accommodating the display part 32 may be designed to have a curvy slot structure.

Hereinafter, the operations of the input device 3 of the present invention will be illustrated with reference to FIGS. 2˜4. The input device 3 may be operated in a first operating mode and a second operating mode. When the display part 32 is accommodated within the receiving slot 312, the input part 31 is in the first operating mode and the input part 31 provides a trackpad function. When the display part 32 is exposed outside the receiving slot 312, the input part 31 is in the second operating mode and the input part 31 provides a keyboard function. In particular, when the input device 3 is turned on, the input part 31 is in the first operating mode (i.e. the default operating mode). Consequently, as shown in FIG. 2, a first panel layout L1 is displayed on the first display module 313 under control of the controlling unit 316. Meanwhile, the switching element 315 is triggered by the display part 32 so as to generate the switching signal S3. According to the switching signal S3, the controlling unit 316 controls the input part 31 to be operated in the first operating mode. On the other hand, the wireless transmission module 317 is in wireless communication with the host 41 by the wireless transmission technology. In this embodiment, the first panel layout L1 is a trackpad layout. Consequently, while the user's finger is moved on the input part 31, a cursor (not shown) of the host 41 is controlled to be synchronously moved with the user's finger.

While the user operates the input part 31 by moving the user's finger on the input part 31, the operating signal S2 corresponding to the movement of the user's finger is generated by the touch control module 314, and the operating signal S2 is transmitted to the controlling unit 316. After the operating signal S2 is analyzed and processed by the controlling unit 316, the controlling unit 316 outputs the corresponding input signal Si to the wireless transmission module 317. After the input signal S1 is transmitted from the wireless transmission module 317 to the host 41, the cursor of the host 41 is controlled according to the input signal S1.

As shown in FIG. 2, the first panel layout L1 is displayed on the first display module 313. Furthermore, a second layout icon I2 corresponding to the second operating mode is also displayed on the first display module 313. When the second layout icon I2 is touched by the user, it means that the second layout icon I2 is selected. In response to the selection of the second panel layout icon I2, the controlling unit 316 controls the first display module 313 to display the second panel layout instead of the first panel layout. In this embodiment, the second panel layout is a keyboard keypad layout. Consequently, although the input part 31 is in the first operating mode, the keyboard function corresponding to the second operating mode can be enabled.

Then, the user may pull out the display part 32 from the receiving slot 312. When the display part 32 is removed from the receiving slot 312, the switching element 315 is no longer triggered by the display part 32. Consequently, the switching element 315 stops generating the switching signal S3 to the controlling unit 316. Since the switching signal S3 is not received by the controlling unit 316, the operating mode of the input part 31 is switched to the second operating mode under control of the controlling unit 316. Meanwhile, as shown in FIG. 4, the controlling unit 316 controls the first display module 313 to display the second panel layout L2. In this embodiment, the second panel layout L2 is an English keyboard keypad layout. That is, when the user's finger touches a key icon displayed on the input part 31, the host 41 is controlled to generate the corresponding character or the corresponding symbol.

While the user operates the input part 31 by touching the key icon of the input part 31 with the user's finger, the operating signal S2 corresponding to the touched key icon is generated by the touch control module 314, and the operating signal S2 is transmitted to the controlling unit 316. After the operating signal S2 is analyzed and processed by the controlling unit 316, the controlling unit 316 outputs the corresponding input signal S1 to the wireless transmission module 317. After the input signal S1 is transmitted from the wireless transmission module 317 to the host 41, the character or the symbol corresponding to the touched key icon is generated according to the input signal S1.

While the input part 31 is operated in the second operating mode under control of the controlling unit 316, an image request signal S5 is outputted from the controlling unit 316 to the wireless transmission module 317, and then the image request signal S5 is transmitted from the wireless transmission module 317 to the electronic device 4. Moreover, according to the image request signal S5, the display signal S4 corresponding to the display content is transmitted from the electronic device 4 to the wireless transmission module 317, and then the display signal S4 is transmitted from the wireless transmission module 317 to the display part 32. According to the display signal S4 from the electronic device 4, the display content displayed on the display screen 42 is synchronously displayed on the second display module 322. Since the input device 3 has both of the displaying function and the inputting function, the user may operate the input device 3 to control the electronic device 4 without the need of staying in front of the electronic device 4. For example, when the electronic device 4 is placed in a study room of a house and the input device 3 is in wireless communication with the electronic device 4, the user in a living room of the house can view the display content displayed on the display part 32 and operate the input part 31 to generate the input signal S1 to control the electronic device. In other words, the user can control the electronic device 4 without the need of staying near the electronic device 4.

The following two aspects should be specially described. Firstly, as shown in FIG. 4, the second panel layout L2 is displayed on the first display module 313. Furthermore, a first layout icon I1 corresponding to the first operating mode and a third layout icon I3 are also displayed on the first display module 313. When the third layout icon I3 is touched by the user, it means that the third layout icon I3 is selected. In response to the selection of the third layout icon I3, the controlling unit 316 controls the first display module 313 to display a Chinese keyboard keypad layout instead of the English keyboard keypad layout. When the first layout icon I1 is touched by the user, it means that the first layout icon I1 is selected. In response to the selection of the first layout icon IL the controlling unit 316 controls the first display module 313 to display the first panel layout (i.e. the trackpad layout) instead of the second panel layout. Consequently, although the input part 31 is in the second operating mode, the keyboard function corresponding to the first operating mode can be enabled.

Secondly, in this embodiment, the controlling unit 316 may allow the input part 31 to execute the trackpad function when the display part 32 is accommodated within the receiving slot 312 and allow the input part 31 to execute the keyboard function when the display part 32 is exposed outside the receiving slot 312. It is noted that numerous modifications and alterations may be made while retaining the teachings of the invention. For example, in another embodiment, the controlling unit may allow the input part to execute the keyboard function when the display part is accommodated within the receiving slot and allow the input part to execute the trackpad function when the display part is exposed outside the receiving slot.

Alternatively, in another embodiment, the first layout icon I1, the second layout icon I2, the third layout icon I3, a fourth layout icon and a fifth layout icon are simultaneously displayed on the first display module 313. For example, when the fourth layout icon is touched by the user, it means that the fourth layout icon is selected. In response to the selection of the fourth layout icon, the controlling unit 316 controls the first display module 313 to display a Japanese keyboard keypad layout or any other appropriate keyboard keypad layout in a different language. When the fifth layout icon is touched by the user, it means that the fifth layout icon is selected. In response to the selection of the fifth layout icon, the controlling unit 316 controls the first display module 313 to display the keyboard layout and the trackpad layout simultaneously. Under this circumstance, both of the keyboard function and the trackpad function can be executed.

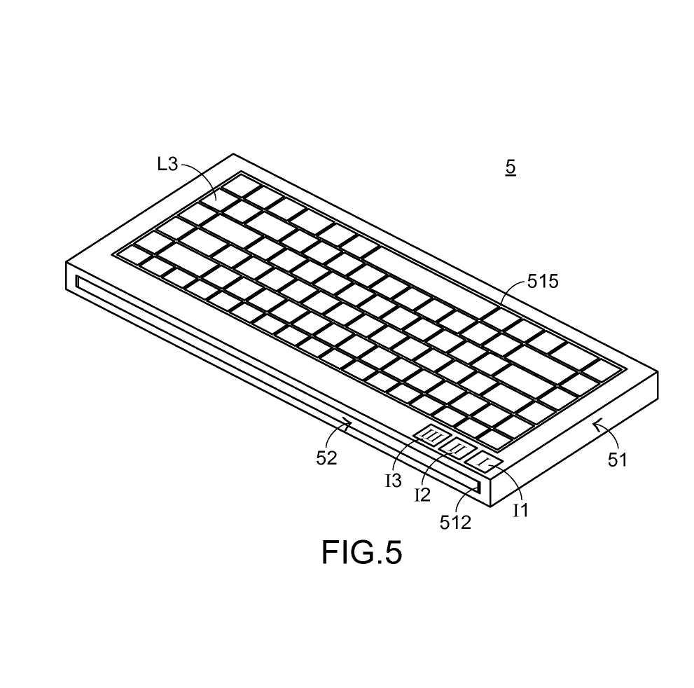

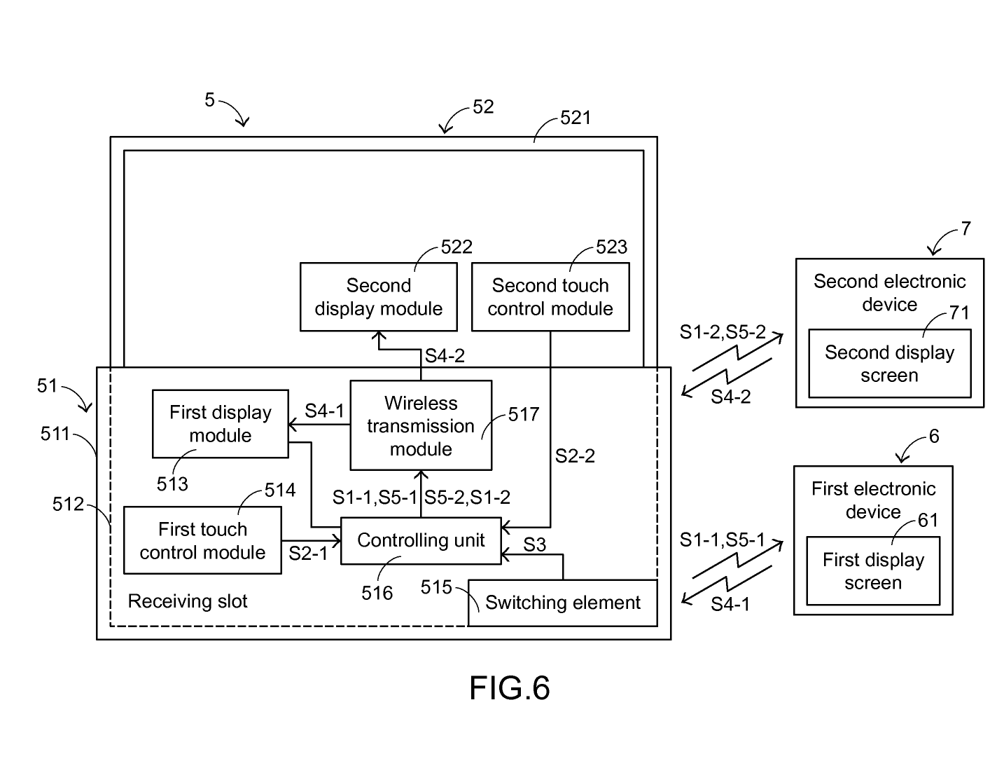

The present invention further provides a second embodiment, which is distinguished from the first embodiment. Hereinafter, the structure of an input device according to a second embodiment of the present invention will be illustrated with reference to FIGS. 5 and 6. FIG. 5 is a schematic perspective view illustrating the input device according to a second embodiment of the present invention. FIG. 6 is a schematic functional block diagram illustrating the relationship between plural electronic devices and the input device according to the second embodiment of the present invention. The input device 5 can be in communication with a first electronic device 6 and a second electronic device 7 in order to control the first electronic device 6 and the second electronic device 7. In this embodiment, the input device 5 comprises an input part 51 and a display part 52. The input part 51 is in communication with the first electronic device 6 and the second electronic device 7. In response to the user's input operation on the input part 51, the input part 51 issues a first input signal S1-1 to the first electronic device 6 or issues a second input signal S1-2 to the second electronic device 7. In this embodiment, the input part 51 comprises a casing 511, a receiving slot 512, a first display module 513, a first touch control module 514, a switching element 515, a controlling unit 516 and a wireless transmission module 517. In comparison with the input device 3 of the first embodiment, the structure of the display part 52 of the input device 5 and the operations of the controlling unit 516 and the wireless transmission module 517 are distinguished. The structures of the other components of the input device 5 are identical to those of the input device 3, are not redundantly described herein.

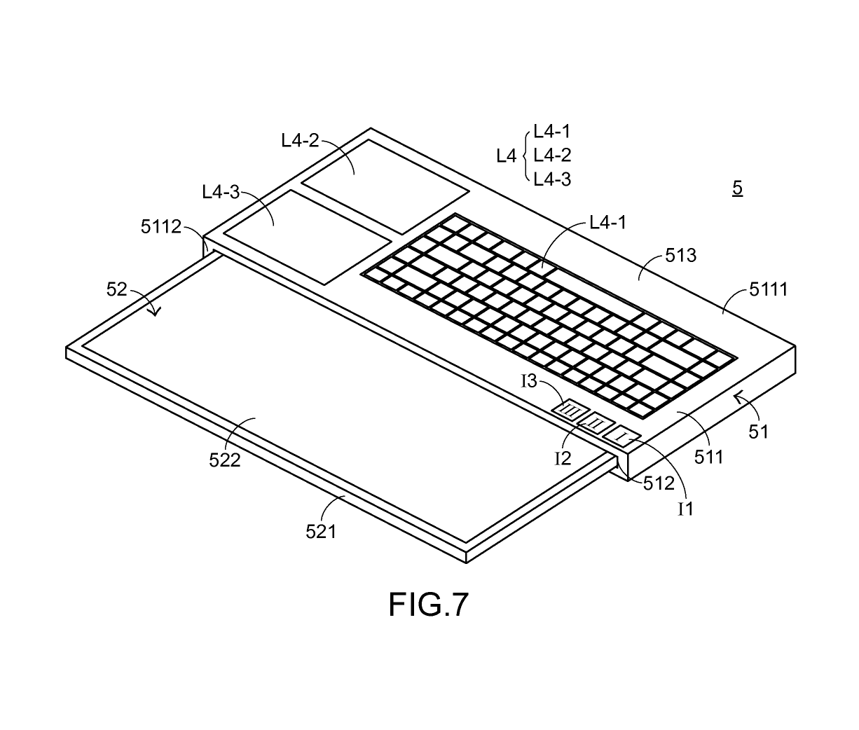

Hereinafter, the structure of the display part 52 will be illustrated with reference to FIGS. 5-7. FIG. 7 is a schematic perspective view illustrating the input device according to the second embodiment of the present invention, wherein the input part is in a second operating mode. In this embodiment, the display part 52 comprises a frame 521, a second display module 522 and a second touch control module 523. The frame 521 may be moved relative to the input part 51 so as to be accommodated within the receiving slot 512 or exposed outside the receiving slot 512. The second display module 522 is disposed within the frame 521 and exposed to a top surface of the display part 52. The second display module 522 is connected with the wireless transmission module 517. According to a second display signal S4-2 from the second electronic device 7, the display content displayed on a second display screen 71 of the second electronic device 7 may be displayed on the second display module 522. In this embodiment, the second touch control module 523 is stacked on the second display module 522 and connected with the wireless transmission module 517. In response to a second input operation on the input part 51, the second touch control module 523 issues the second input signal S1-2 to the wireless transmission module 517. The second input signal S1-2 is further transmitted from the wireless transmission module 517 to the second electronic device 7. In other words, the display part 52 also provides the inputting function.

As shown in FIG. 6, the wireless transmission module 517 is disposed within the input part 51 and connected with the controlling unit 516. Through the wireless transmission module 517, the input device 5 may be in wireless communication with the first electronic device 6 and the second electronic device 7. Consequently, the first input signal S1-1 may be transmitted from the wireless transmission module 517 to the first electronic device 6, the second input signal S1-2 may be transmitted from the wireless transmission module 517 to the second electronic device 7, a first display signal S4-1 corresponding to the display content from the first electronic device 6 may be received by the wireless transmission module 517, or a second display signal S4-2 corresponding to the display content from the second electronic device 7 may be received by the wireless transmission module 517.

In addition to the operations described in the first embodiment, the controlling unit 516 has to assign the input signal to the accurate electronic device. For example, when the user operates the first electronic device 6, the first input signal S1-1 generated in response to the input operation has to be assigned to the first electronic device 6. Consequently, the first input signal S1-1 will be transmitted from the wireless transmission module 517 to the first electronic device 6. Moreover, the controlling unit 516 has to assign the display signal to the accurate display module. For example, since the second display module 522 corresponds to the second electronic device 7, the controlling unit 516 has to assign the second display signal S4-2 to the second display module 522. Consequently, the display content of the second electronic device 7 can be displayed on the second display module 522.

Hereinafter, the operations of the input device 5 of the present invention will be illustrated with reference to FIGS. 5˜7. When the input device 5 is turned on, the input part 51 is in the first operating mode (i.e. the default operating mode). Consequently, as shown in FIG. 5, a first panel layout L3 is displayed on the first display module 513 under control of the controlling unit 516. Meanwhile, the switching element 515 is triggered by the display part 52 so as to generate the switching signal S3. According to the switching signal S3, the controlling unit 516 controls the input part 51 to be operated in the first operating mode. On the other hand, the wireless transmission module 517 is in communication with the first electronic device 6 and the second electronic device 7 by the wireless transmission technology. After the wireless transmission module 517 is in communication with the first electronic device 6 and the second electronic device 7, the controlling unit 516 is preset to assign the first touch control module 514 to the first electronic device 6 and assign the second touch control module 523 to the second electronic device 7. In this embodiment, the first panel layout L3 is a keyboard keypad layout.

While the user operates the input part 51 by touching a key icon of the input part 51 with the user's finger, the first operating signal S2-1 corresponding to the touched key icon is generated by the first touch control module 514, and the first operating signal S2-1 is transmitted to the controlling unit 516. After the first operating signal S2-1 is analyzed and processed by the controlling unit 516, the controlling unit 516 outputs the corresponding first input signal S1-1 to the wireless transmission module 517. After the first input signal S1-1 is transmitted from the wireless transmission module 517 to the first electronic device 6, the character or the symbol corresponding to the touched key icon is generated according to the first input signal S1-1.

Then, the user may pull out the display part 52 from the receiving slot 512. When the display part 52 is removed from the receiving slot 512, the switching element 515 is no longer triggered by the display part 52. Consequently, the switching element 515 stops generating the switching signal S3 to the controlling unit 516. Since the switching signal S3 is not received by the controlling unit 516, the operating mode of the input part 51 is switched to the second operating mode under control of the controlling unit 516. Meanwhile, as shown in FIG. 7, the controlling unit 516 controls the first display module 513 to display a second panel layout L4. In this embodiment, the second panel layout L4 comprises a keyboard keypad layout zone L4-1 and a trackpad layout zone L4-2, and further comprises a display zone L4-3 corresponding to the display screen (not shown) of the first electronic device 6. When the user's finger touches a key icon displayed on the keyboard keypad layout zone L4-1, the first electronic device 6 is controlled to generate the corresponding character or the corresponding symbol. While the user's finger is moved on the trackpad layout zone L4-2, a cursor (not shown) of the first electronic device 6 is controlled to be synchronously moved with the user's finger. Moreover, a first image request signal S5-1 is outputted from the controlling unit 516 to the wireless transmission module 517, and then the first image request signal S5-1 is transmitted from the wireless transmission module 517 to the first electronic device 6. Moreover, according to the first image request signal S5-1, the first display signal S4-1 corresponding to the display content of the first electronic device 6 is transmitted from the first electronic device 6 to the wireless transmission module 517, and then the first display signal S4-1 is transmitted from the wireless transmission module 517 to the display zone L4-3. According to the first display signal S4-1, the display content on the first display screen 61 is synchronously displayed on the display zone L4-3 of the first display module 513.

While the input part 51 is operated in the second operating mode under control of the controlling unit 516, a second image request signal S5-2 is outputted from the controlling unit 516 to the wireless transmission module 517, and then the second image request signal S5-2 is transmitted from the wireless transmission module 517 to the second electronic device 7. Moreover, according to the second image request signal S5-2, the second display signal S4-2 corresponding to the display content is transmitted from the second electronic device 7 to the wireless transmission module 517, and then the second display signal S4-2 is transmitted from the wireless transmission module 517 to the display part 52. According to the second display signal S4-2 from the second electronic device 7, the display content on the second display screen 71 of the is synchronously displayed on the second display module 522.

Since the display part 52 further comprises the second touch control module 523, the display part 52 has both of the displaying function and the inputting function. Consequently, the user may operate the input part 51 to control the first electronic device 6 without the need of staying in front of the first electronic device 6 and the second electronic device 7. Moreover, the user may operate the second touch control module 523 of the display part 52 to generate the second operating signal S2-2. According to the second operating signal S2-2, the second input signal S1-2 is outputted from the controlling unit 516 to the second electronic device 7 so as to control the second electronic device 7. The operations of the input part 51 are similar to those of the first embodiment, and the operations of the display part 52 are similar to the operations of a tablet computer (not shown).

Furthermore, a first layout icon I1, a second layout icon I2 and a third layout icon I3 are simultaneously displayed on the first display module 513 of the display part 51. In an embodiment, the first layout icon I1 corresponds to the first panel layout L3, the second layout icon I2 corresponds to the second panel layout L4, and the third layout icon I3 corresponds to the simple trackpad layout. Alternatively, according to settings, the third layout icon I3 may correspond to another panel layout with the keyboard keypad layout zone and the trackpad layout zone but without the display zone.

From the above descriptions, the input device of the present invention comprises the input part and the display part. In the input part, the touch control module may be triggered through touch control. Moreover, the input part further comprises the first display module.

According to the user's requirement, different panel layouts may be selectively displayed on the first display module in order to provide different inputting functions. The display part may be moved relative to the input part so as to be accommodated within the input part or exposed outside the input part. Moreover, the display content on the display screen of the electronic device which is in wireless communication with the input device may be displayed on the display part. Since the input part is implemented with a touch panel, the input device has slim outer appearance and is easily carried. Moreover, the user may operate the input device to control the electronic device without the need of staying in front of the electronic device. Consequently, the input device of the present invention has operating convenience and slim outer appearance. More especially, since the user can control the electronic device at any site through the input device of the present invention, the operating utilization of the input device is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An input device in communication with an electronic device, the input device comprising:
an input part in communication with the electronic device, wherein in response to an input operation on the input part, an input signal is transmitted from the input part to the electronic device, wherein the input part comprises a receiving slot; and
a display part selectively accommodated within the receiving slot or exposed outside the receiving slot, wherein when the display part is moved relative to the input part to be exposed outside the receiving slot, a display content on a display screen of the electronic device is displayed on the display part, wherein when the display part is accommodated within the receiving slot, the input part is in a first operating mode, wherein when the display part is moved relative to the input part to be exposed outside the receiving slot, the input part is in a second operating mode.

2. The input device according to claim 1, wherein the input part further comprises:
a switching element disposed within the receiving slot, wherein when the switching element is triggered through the display part, a switching signal is generated; and
a controlling unit disposed within the input part and connected with the switching element, wherein according to the switching signal, the input part is switched from the first operating mode to the second operating mode or switched from the second operating mode to the first operating mode.

3. The input device according to claim 2, wherein the input part further comprises:
a casing;
a first display module disposed within the casing and exposed to a top surface of the casing; and
a first touch control module stacked on the first display module, wherein in response to the input operation on the first touch control module, the first touch control module issues the input signal, wherein when the input part is in the first operating mode, the controlling unit controls the first display module to display a first panel layout, wherein when the input part is in the second operating mode, the controlling unit controls the first display module to display a second panel layout.

4. The input device according to claim 3, wherein plural layout icons are further displayed on the first display module, wherein when the layout icon corresponding to the first panel layout is selected, the controlling unit controls the first display module to display the first panel layout, wherein when the layout icon corresponding to the second panel layout is selected, the controlling unit controls the first display module to display the second panel layout.

5. The input device according to claim 3, wherein the first display module and the touch control module are collaboratively formed as a touch panel.

6. The input device according to claim 2, wherein the input part further comprise a wireless transmission module, and the wireless transmission module is disposed within the input part and connected with the controlling unit, wherein the input device is in wireless communication with the electronic device through the wireless transmission module, so that the input signal of the input part is transmitted from the wireless transmission module to the electronic device or a display signal corresponding to the display content from the electronic device is received by the wireless transmission module.

7. The input device according to claim 6, wherein the display part comprises:
a frame movable relative to the input part, wherein the frame is selectively accommodated within the receiving slot or exposed outside the receiving slot; and
a second display module disposed within the frame and exposed to a top surface of the display part, wherein the second display module is connected with the wireless transmission module, and the display content on the display screen is displayed on the second display module according to the display signal, wherein when the controlling unit controls the input part to be in the second operating mode according to switching signal, the controlling unit requests the display content of the display screen from the electronic device through the wireless transmission module, so that the display signal is received by the second display module.

8. The input device according to claim 7, wherein the second display module is composed of plural organic light-emitting diodes.

9. The input device according to claim 7, wherein when the input device is in wireless communication with a second electronic device through the wireless transmission module, a second display signal corresponding to a second display content is transmitted from the second electronic device to the input device through the wireless transmission module, and the second display content is displayed on the second display module according to the second display signal.

10. The input device according to claim 9, wherein the display part further comprises a second touch control module, and the second touch control module is stacked on the first display module and connected with the wireless transmission module, wherein in response to a second input operation on the second touch control module, the second touch control module issues a second input signal to the second electronic device through the wireless transmission module.
